(19) United States
(12) Patent Application Publication
(10) Pub. No.: US 2012/0138666 A1
(43) Pub. Date: Jun. 7, 2012

(54) Folder with fold down divider tab shield

(76) Inventor: Bon S. Ong, Carson, CA (US)

(21) Appl. No.: 13/065,978

(22) Filed: Apr. 4, 2011

(30) Foreign Application Priority Data
Dec. 1, 2010 (CN) 201020635963.6

(51) Int. Cl. B42F 7/08; B42F 23/00; B42F 21/00

(52) U.S. Cl. 229/67.3; 229/67.4; 283/37; 281/45

(57) ABSTRACT

A file folder is comprised of the conventional elements of a back cover, a plurality of compartment dividers, and a front cover located in front of the compartment dividers. According to the novel features of the invention the front cover is formed of a lower face portion and an upper shield portion delineated from the lower face portion by a laterally extending fold that extends across the entire width of the front cover. The upper shield portion is biased toward an extended disposition to project upwardly above the upper edges of the compartment dividers. Furthermore, a latch is provided on the upper shield portion and a catch is located on the lower face portion of the front cover. The catch is engageable with the latch when at least part of the shield portion is forced downwardly, bending in articulated fashion into a disposition facing the lower face portion. When all or part of the upper shield portion is in this folded disposition the upper regions and index tabs of the compartment dividers are clearly visible and accessible from in front of the file folder.

### BACKGROUND OF THE INVENTION

1. Field of the Invention

The present invention relates to a portable file folder and a system for facilitating viewing and access to the index tabs of dividers within the folder when the folder is opened.

2. Description of the Prior Art

Some conventional portable file folders are provided with closure flaps that fold over the top of the folder to securely encase and protect the contents of the file folder when the file folder is transported, stacked, stored or otherwise maintained in a closed condition. The closure flaps of such folders prevent the contents of the folders from spilling out, and also protect the contents from damage that might otherwise result from exposure to inclement weather, beverage spills and other conditions that might damage papers or other articles that are stored in the folders.

Conventional folder flaps do present certain difficulties in utilizing the folders bearing them, however. Conventional folder flaps are normally constructed as extensions of a back panel or back cover of the folder and are typically biased to a closed condition covering the tops of any dividers within the folders. While such a construction aids in protecting and preventing damage to the contents of the folder, folder flaps of this type also hinder easy viewing and access to divider tabs and the dividers within the folder pocket. That is, conventional folder flaps tend to drop down over the tops of the compartment dividers, thereby obscuring them both visually and hindering physical access. The folder flaps can be drawn back out of the way. However, this typically occupies one of the users hands, thereby reducing the ability of the user to manipulate the folder dividers so as to easily extract documents from a particular compartment within the folder pocket.

Other portable file folders are constructed without closure flaps. One manner of construction is to create a file folder with front and back panels that extend at least as high, and often slightly higher, then the index tabs on the dividers within the folder pockets. The extension of the front and back covers above the level of the divider tabs does provide some protection to the divider tabs. That is, this construction reduces excessive bending of the tabs and premature dilapidated of the file divider tabs. Such a construction eliminates the problem of a folder flap dropping down over the tops of the dividers. Nevertheless, the relatively high front cover or front panel of such a folder also visually obscures the divider tabs and in addition impairs physical access to the folder compartments.

### SUMMARY OF THE INVENTION

The present invention solves the deficiencies of the prior art portable file folder constructions which produce problems with both visual and physical access to the divider tabs. According to the present invention the front cover or panel, while extending upwardly to at least the level of the divider tabs, is also provided with a transverse fold. The upper part of the front cover or panel can be folded down to face the lower part, thereby providing easy access to the file folder divider tabs. Moreover, the front cover or panel is provided with a fastening mechanism, which may include a catch and a latch. These fastening elements allow at least part of the upper portion of the front cover not only to be folded down against the lower portion, but to be held in this condition until such time as the user is finished using the folder. This frees both of the users hands. The file folder of the invention thereby provides the advantages of protection of the divider tabs, but without the disadvantage of interfering with viewing and access to them when the folder is in use.

In one broad aspect the present invention may be considered to be a file folder comprising a back cover, a plurality of compartment dividers, a front cover and a fastener mechanism. Each of the dividers is located in front of the back cover and has an upper edge and a lower edge. The dividers define filing compartments within the folder pouch. The front cover is formed of a lower face portion and an upper shield portion which are delineated from each other by a laterally extending fold that extends across the width of the front cover. The upper shield portion is biased toward an extended disposition to project upwardly above the upper edges of the compartment dividers. A latch is located on the upper shield portion and a catch is located on the lower face portion. The latch and catch are engageable with each other when the shield portion is forced downwardly. At least part of the shield portion bends in articulated fashion from the lower face portion into a disposition facing the lower face portion, whereupon the latch is engageable with the catch.

In another broad aspect the invention may be considered to be a portable file folder comprising a pocket in which a plurality of dividers are located wherein. The pocket has a back and a front. Both the back and the front are high enough to extend at least as high as the upper extremities of the dividers. The front includes a front upper portion, a front lower portion and a transverse fold extending across the front, whereby the front upper portion and the front lower portion lie on opposite sides of the transverse fold. The front upper portion is biased to an extended position projecting upwardly from the front lower portion in front of the upper extremities of the dividers. At least part of the front upper portion is foldable downwardly to a collapsed position disposed against the front lower portion to expose the upper extremities of the dividers. The front upper portion has a first fastening element and the front lower portion has a second fastening element that mates with the first fastening element. The second fastening element engages the first fastening element when the front upper portion is in the collapsed position.

In still another broad aspect the invention may be considered to be a file folder having a back panel, a front panel and at least one divider disposed therebetween to delineate a plurality of compartments between the front and back panels. Each divider has an upper region. The front panel has a front lower portion and an upper shield portion delineated from each other by a transverse fold. The upper shield portion is biased to project upwardly from the front lower portion in an extended condition in front of the upper region of the divider or dividers. The front panel is bendable to bring at least part of the upper shield portion into a folded condition facing the front lower portion. The upper shield portion is provided with a first releasable fastening a member and the front lower portion is provided with a second releasable fastening number. The fastening members are engageable when the shield portion is in the folded condition.

The invention may be described with greater clarity and particularity by reference to the accompanying drawings.

### DESCRIPTION OF THE DRAWINGS

FIG. 1 is a perspective view illustrating one preferred embodiment of a portable file folder according to the invention shown in a closed condition

FIG. 2 is a front elevational view of the embodiment of FIG. 1.

FIG. 3 is a perspective view illustrating the embodiment of FIG. 1 shown in an open condition with the upper shield portion deflected partially from its extended position.

FIG. 4 is a sectional view taken along the lines 4-4 of FIG. 3.

FIG. 5 is an enlarged detail of a portion of the embodiment of FIG. 1 as shown at 5 in FIG. 4.

FIG. 6 is a perspective view illustrating the embodiment of FIG. 1 shown in an open condition with the upper shield portion deflected further from its extended position.

FIG. 7 is a perspective view illustrating the embodiment of FIG. 1 shown in a collapsed condition with the top part of the upper shield portion formed as an engagement of flap deflected completely from its extended position to its folded position.

FIG. 8 is an enlarged perspective detail illustrating the latch and catch mechanism engaged with each other as shown at 8 in FIG. 7.

FIG. 9 is a front elevational view of an alternative embodiment of the invention with the upper shield portion of the front cover shown in an extended condition.

FIG. 10 is a front elevational view of another alternative embodiment of the invention with the upper shield portion of the front cover shown in an extended condition.

FIG. 11 is a front elevational view of still another alternative embodiment of the invention with the upper shield portion of the front cover shown in an extended condition.

FIG. 12 is a perspective view of another alternative embodiment of the invention

FIG. 13 is a perspective view of still another alternative embodiment of the invention.

### DESCRIPTION OF THE EMBODIMENT

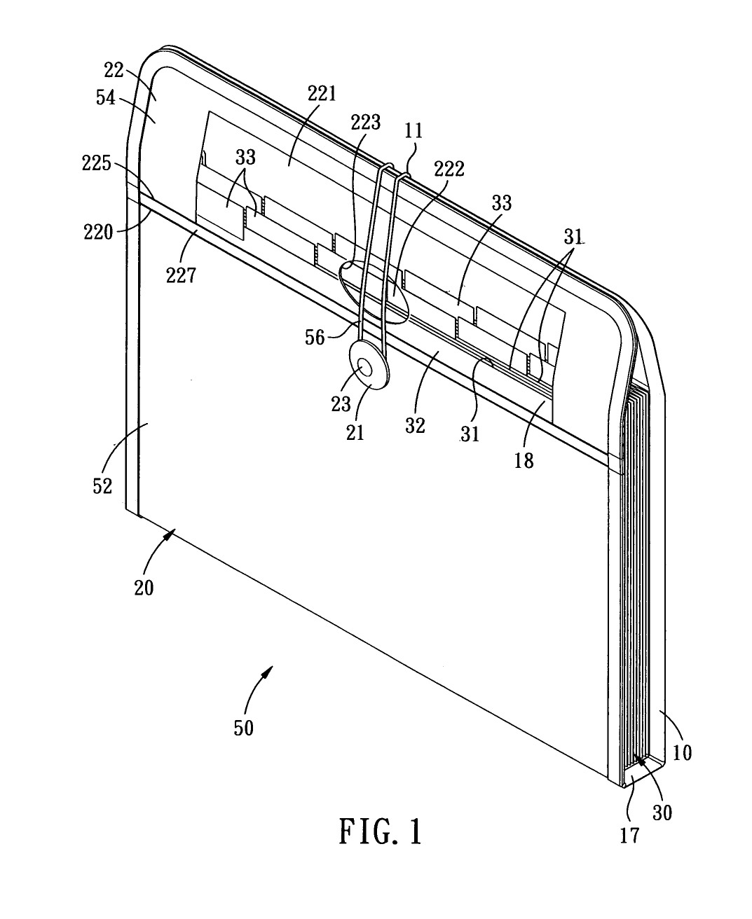

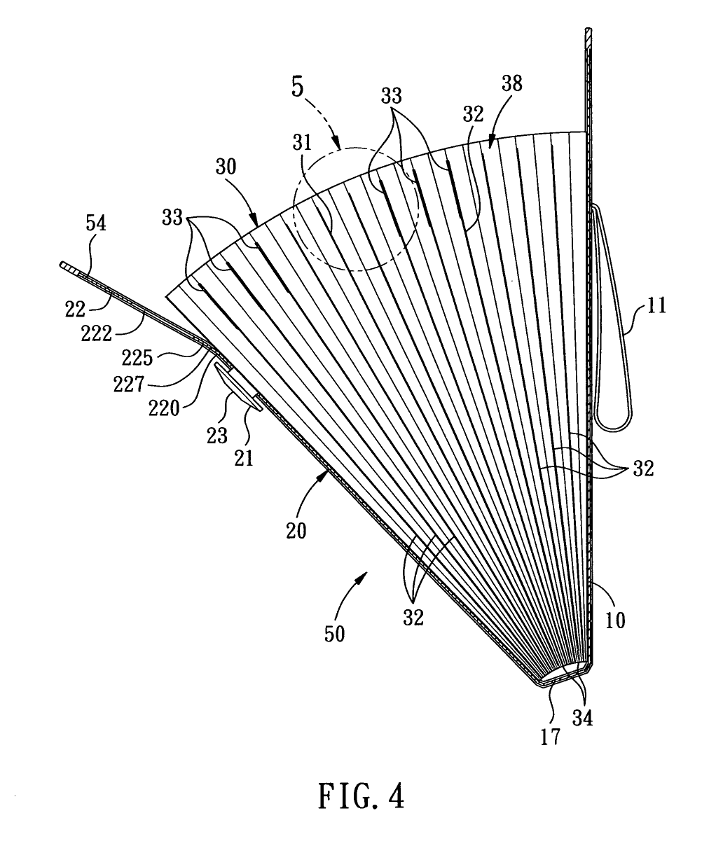

FIG. 1 illustrates a portable file folder 50 constructed according to the present invention. The portable file folder 50 is comprised of a generally rectangular back cover 10 a top with having rounded upper corners, a generally rectangular front cover 20 also having a top with rounded upper corners, and a plurality of compartment dividers 32. Each of the compartment dividers 32 has an upper edge 31 and an opposite lower edge 34 located just above the relatively narrow, generally rectangular file folder floor 17 that connects the bottom of the back cover 10 and the bottom of the front cover 20 together. Each file folder compartment divider 32 has an upper region 18 located just below its upper edge 31 and an index tab 33 projecting upwardly from its upper edge 31. The compartment dividers 32 divide the pouch or pocket 38 of the portable file folder 50 into a plurality of different filing compartments. The different compartments are designed to receive documents as classified by the user. The division of the file folder into compartments is best illustrated in FIG. 4.

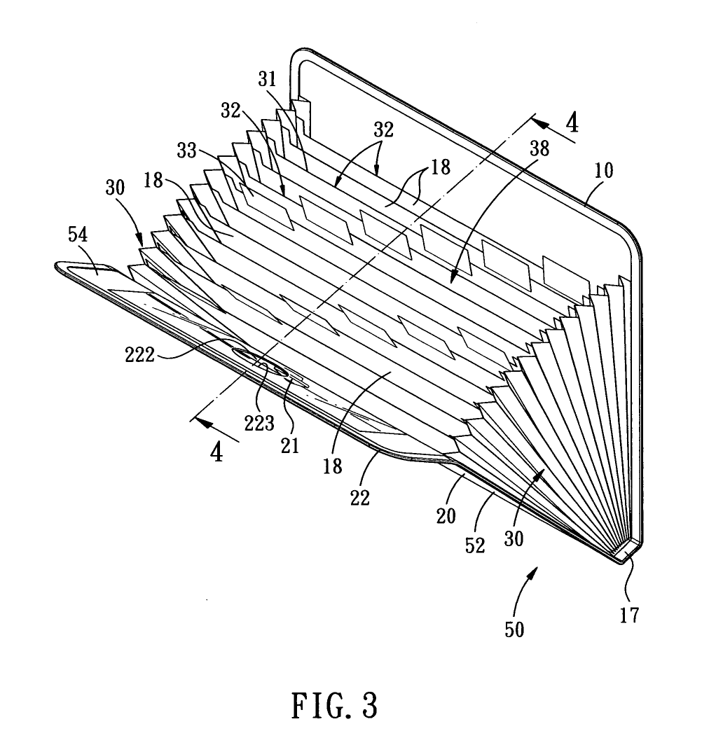

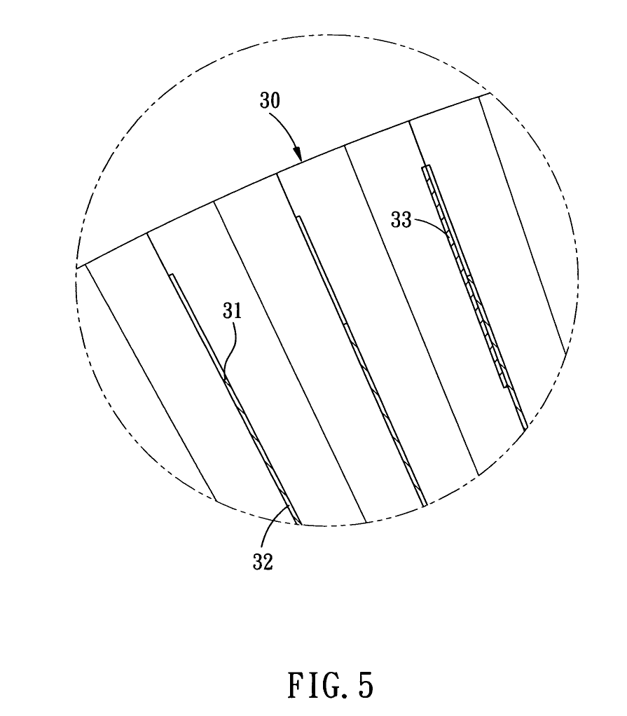

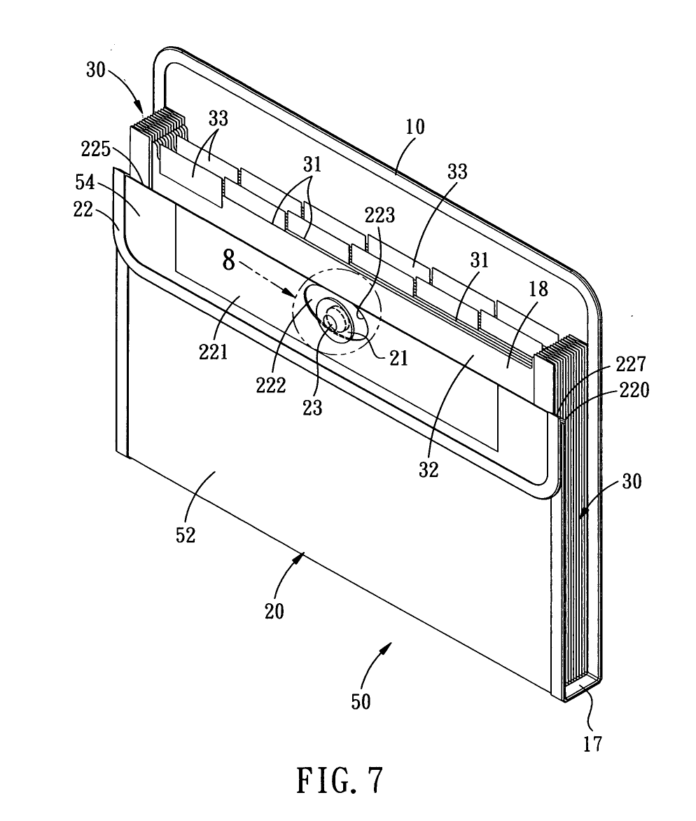

The portable file folder 50 has a pair of end closure of panels 30 folded in pleated fashion in accordion folds and joining the back cover 10 and front cover 20 together at the laterally opposing ends of the portable file folder 50. The portable file folder 50 is thereby constructed as an accordion file that may be collapsed as illustrated in FIGS. 1 and 7 and expanded as illustrated in FIGS. 3-6. While the floor 17 in the embodiment of FIGS. 1-8 is a nonexpandable, flat floor of fixed dimensions, the floor of the file folder 50 could be fully pleated, just like the end closure panels 30. In such a construction the file folder could be completely expandable in accordion fashion from top to bottom, rather than expandable only at the top in the generally V-shaped configuration shown in FIG. 4.

The dividers 32 are all located in front of the back cover 10, and the front cover 20 is located in front of all of the compartment dividers 32. The front cover 20 is formed with a lower face portion 52 and an upper face portion 22. The upper face portion 22 may also be considered to be an upper shield portion. The front cover 20 may be constructed of opaque plastic and a transparent window 221 may be defined in it, as illustrated in the embodiment of FIGS. 1-8. The upper shield portion 22 is separated from the lower face portion 52 by a transverse laterally extending fold 220 that extends across the entire width of the front cover 20. Part of the upper shield portion 22 is formed as an engagement flap 54 while the remaining part of the upper shield portion 22 is formed as a narrow offset strip 227. The engagement flap 54 and the narrow offset strip 227 are delineated from each other by an offset crease 225.

The front cover 20 is constructed of a relatively stiff material, such as Manila cardstock or polypropylene plastic. The stiffness of the front cover 20 thereby biases the upper shield portion 22 toward an extended disposition to project upwardly above the height of the upper edges 31 of the pocket dividers 32 and also above the height of the index tabs 33 extending upwardly from the upper edges 31 of the compartment dividers 32.

The portable file folder 50 has a fastening mechanism that in the embodiment of FIG. 1 is comprised of a latch formed as a laterally elongated, oval shaped buttonhole opening 222 defined by an inner closed loop latching aperture edge 223 within the upper shield portion 22, and a catch formed as a disk shaped plastic button 21. The catch button 21 is secured at its center by a plastic rivet 23 to the lateral center of the lower face portion 52 of the front cover 20 below the laterally extending fold 220.

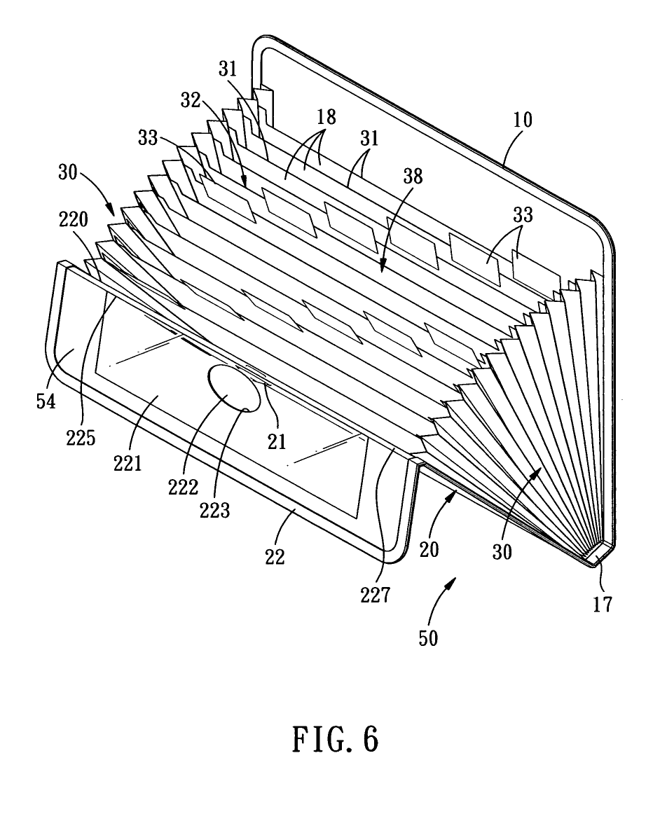

The offset crease 225 passes through the oval shaped buttonhole latch opening 222 near its lower edge. The latch buttonhole opening 222 in the upper shield portion 22 is a first fastening element or member and is located above the transverse laterally extending fold 220. The catch button 21 is a second fastening element or member and is located below both the transverse laterally extending fold 220 and the offset crease 225. The latch buttonhole opening 222 and the catch button 21 are spaced from each other distances such that the catch button 21 is engageable with the latch buttonhole opening 222 when the shield portion 22 is forced downwardly, bending in articulated fashion about the transverse crease 225, as illustrated in FIGS. 3 and 4 into a disposition in which the engagement flap 54 of the upper shield portion 22 faces the lower face portion 52. When the upper shield portion 22 is bent in this manner it is in a collapsed position, as illustrated in FIG. 6. When the shield portion 22 is collapsed, as illustrated in FIG. 6, the upper extremities all the dividers 32, including the upper regions 18, the upper edges 31 and the divider index tab 33, are fully visually exposed and easily accessible for manipulation.

The offset crease 225 is defined through the upper shield portion 22 and the lower face portion 52 of the front cover 20 parallel and proximate to the laterally transverse extending fold 220 to improve the stability of the engagement of the catch button 21 with the latch buttonhole opening 222. The offset crease 225 thereby divides the upper shield portion 22 into two parts. In the embodiment of FIGS. 1-8 the transverse fold 225 passes through the buttonhole opening 222 near its lower extremity and divides the upper shield portion 22 into the intermediate offset strip 227 and the engagement flap 54. The laterally extending fold 220 defines the demarcation between the upper shield portion 22 and the lower face portion 52 of the front cover 20.

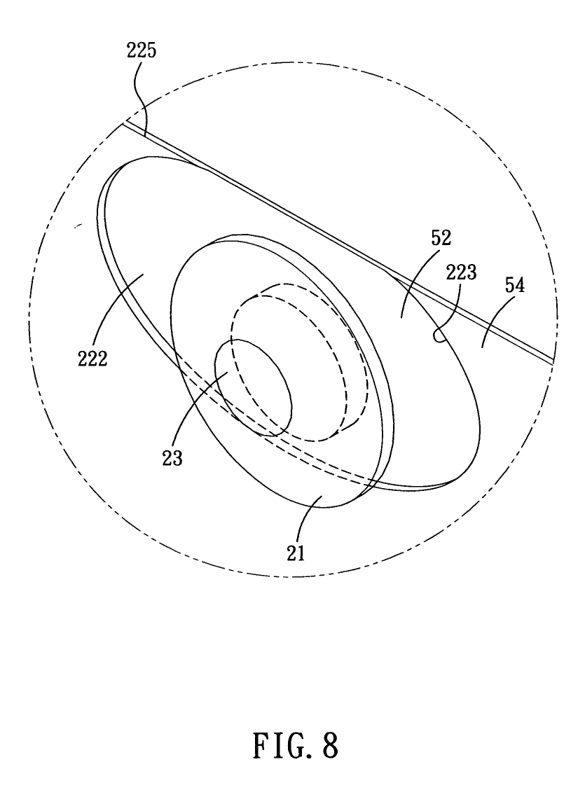

The location of the laterally extending fold 220 delineates the lower front portion 52 from the upper shield portion 22. The formation of the offset strip 227 aids in maintaining the catch button 21 engaged in the latch buttonhole opening 222. That is, due to the stiffness of the material of the front cover 20, as the upper edge of the buttonhole latch opening 222 is pulled downwardly over the lower edge of the button 21, as illustrated in FIG. 6, the stiffness of the material of the front cover 20 combined with the existence of the offset strip 227 tends to pull the shield portion 22 upwardly once the lower edge of the button 21 has been inserted through and cleared the buttonhole latch opening 222. The structure of the engagement flap 54 of the upper shield portion 22 is thereby drawn upwardly so that the lower edge of the catch button 21 project below the edge of the buttonhole latch opening 222 immediately adjacent thereto, as shown in FIGS. 7 and 8. The button 21 there by acts as a hook while the inverted adjacent upper edge of the buttonhole opening 222 serves as a latch engaging the hook.

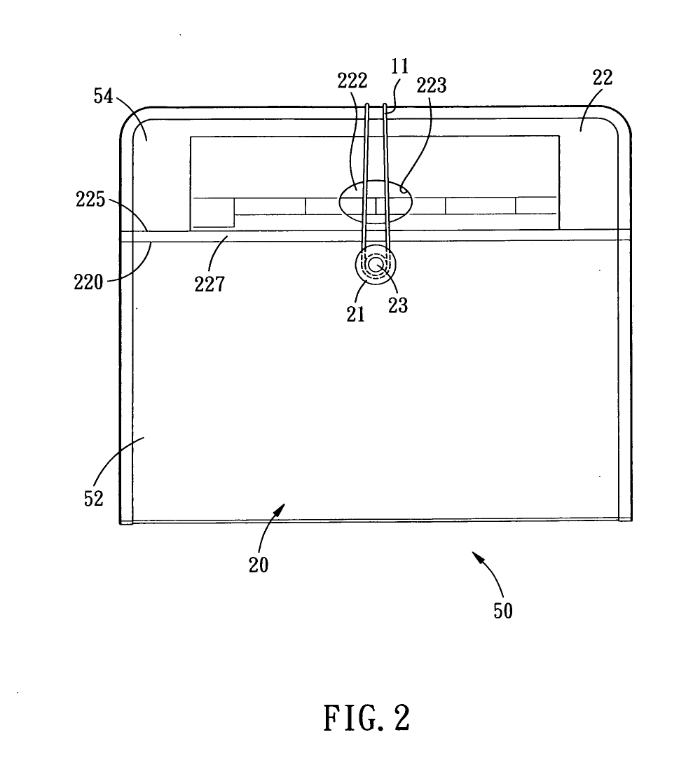

The portable file folder 50 in the embodiment illustrated in FIGS. 1-8 is further comprised of an elastic band 11 that is formed as a loop attached to the upper center of the back cover 10, as shown in FIG. 4. When the accordion file folder 50 is closed, the elastic band 11 is engageable with the button 21 over the tops of the back cover 10 and front cover 20 when the upper shield portion 22 projects upwardly above the upper edges 31 of the compartment dividers 32, as illustrated in FIGS. 1 and 2. The elastic band 11 thereby holds the accordion folder 50 in a collapsed condition with the upper edges of the front cover 20 and back cover 10 drawn into contact with each other. This ensures that the contents of the portable file folder 50 cannot accidentally fall out of the compartments in which they are placed as long as the elastic band 11 remains engaged with the button 21. The button 21 thereby serves the dual function of an anchoring mechanism for holding the file folder closed when the upper shield portion 22 is in the extended disposition with the elastic band 11 engaged, as illustrated in FIGS. 1-2, and holding the engagement flap 54 of the upper shield portion 22 folded down into a disposition facing the lower face portion 52 when the catch button 21 is engaged in the buttonhole latch opening 222, as shown in FIGS. 7 and 8.

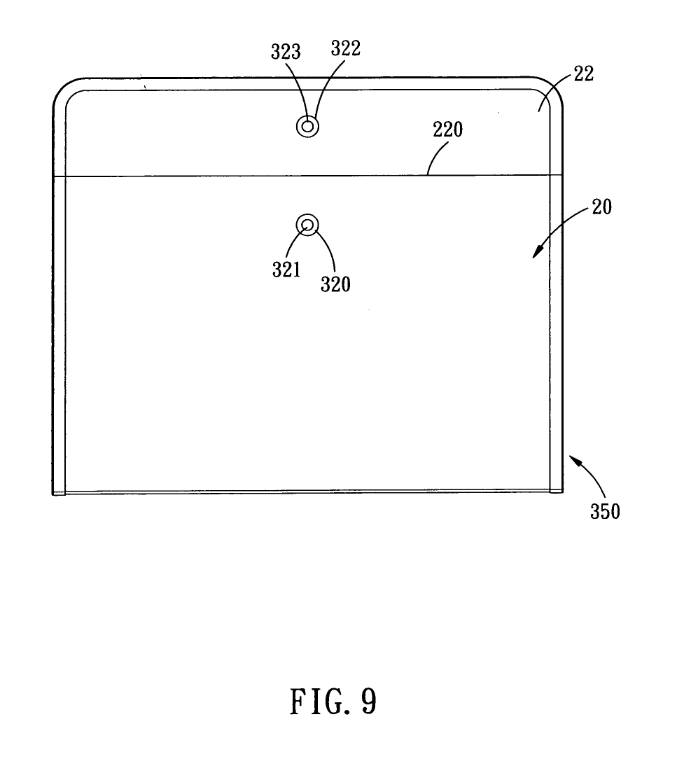

The button and buttonhole arrangement of the embodiment of FIGS. 1-8 is not the only type of fastening element or fastening member arrangement that may be utilized in accordance with the present intention. For example, FIG. 9 illustrates a portable file folder 350 which is similar in many respects to the portable file folder 50, but which has a different and latch and catch fastening arrangement. The laterally extending fold 220 forms the demarcation between the upper shield portion 22 and the lower face portion 52 of the front cover 20. In the embodiment of FIG. 9 a snap fastener assembly is employed in place of the button and buttonhole arrangement. The snap fastener assembly includes a metal or plastic structure 322 that is riveted to the upper shield portion 22 of the front cover 20 and which defines within its structure an outwardly facing socket 323 located a specific distance upwardly from the laterally extending fold 220. A corresponding structure 320 is riveted to the lower face portion 52 of the front cover 20 and includes an outwardly projecting stud 321 located the same specific distance below the laterally extending fold 220. That is, the socket 323 and the stud 321 are equally spaced respectively below and above the laterally extending fold 220.

When the upper shield portion 22 is folded downwardly into a face-to-face disposition relative to the upper region of the lower face portion 52, the stud 321 snaps into and is releasably engaged with the socket 323. Alternatively, when the file folder 350 is closed, the upper shield portion 22 is pulled outwardly, thereby freeing the stud 321 from the socket 323, whereupon the upper shield portion 22 is moved upwardly into the disposition illustrated in FIG. 9 so as to shield the upper regions of the dividers 32. In the embodiment of FIG. 9 there is no necessity for a transverse offset crease.

The locations of the socket 323 and stud 321 can be reversed. That is, the socket 323 could be located on the lower face portion 52 of the front cover 20, while the stud 321 could be located on the upper shield portion 22 of the front cover 20.

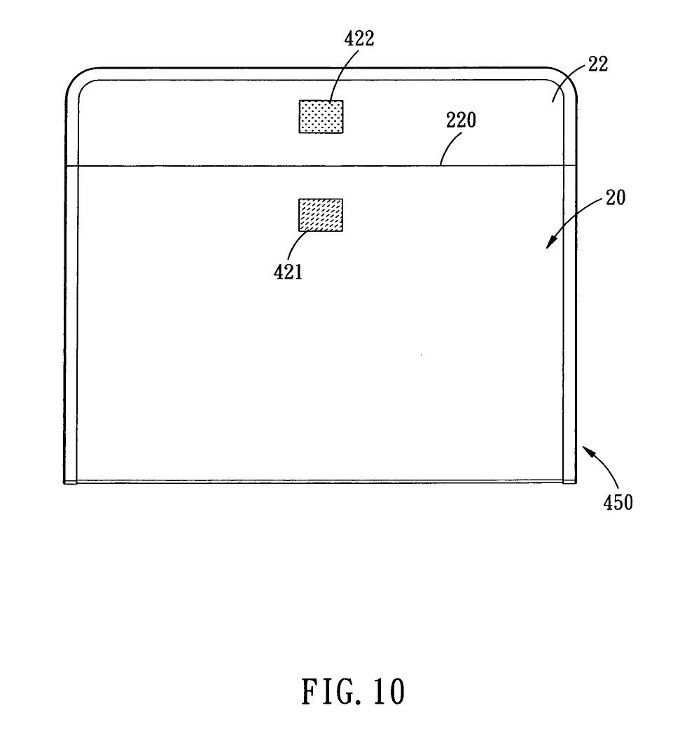

FIG. 10 illustrates another embodiment of the invention showing a portable file folder 450 similar in many respects to the portable file folder 50 but with a different fastening member arrangement. In the embodiment of FIG. 10 the catch and the latch are comprised of a pair of mating pads of hook and loop fastener material of the type sold under the registered trademark Velcro. Specifically, the upper pad 422 bears a multiplicity of minute hooks of stiff plastic while the lower pad 421 bears a loop pile in which the hooks of the pad 422 are releasably engageable. As in the embodiment of FIG. 9, the laterally extending fold 220 forms the demarcation between the upper shield portion 22 and the lower face portion 52, and a transverse crease above the laterally extending fold 220 is unnecessary.

The pads 422 and 421 are respectively located equidistant from each other above and below the laterally extending fold 220. It is apparent that the positions of the pads 421 and 422 can be reversed. That is, the pad 422 bearing the multiplicity of hooks can be located on the lower face portion 52 of the front cover 20, while the pad 421 bearing the loop pile can be located an equal distance above the laterally extending fold 220 on the upper shielding portion 22.

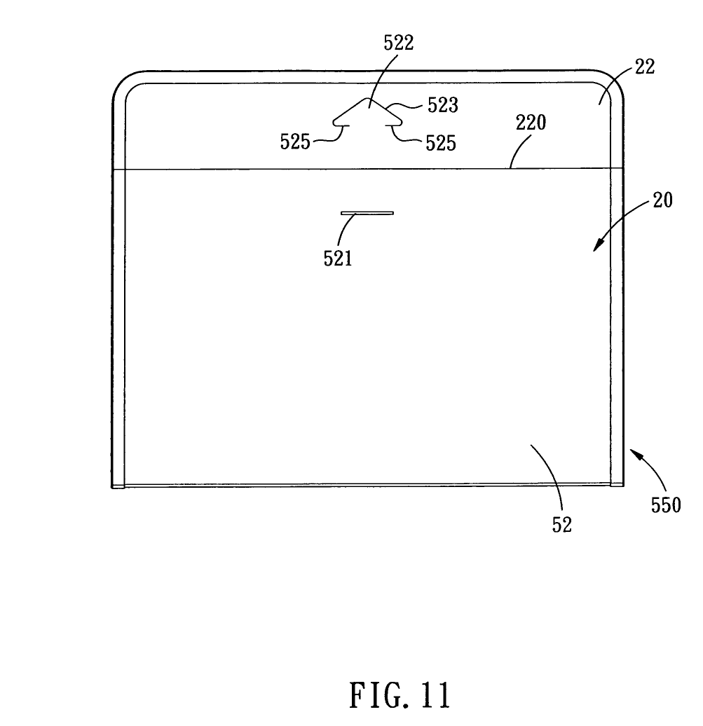

FIG. 11 illustrates still another embodiment of the invention. That drawing figure shows a portable file folder 550 wherein the catch or first fastening element is formed by an arrowhead shaped slit 523 cut into the upper shield portion 22 of the file front cover 20. In this embodiment also the laterally extending fold 220 delineates the upper shielding portion 22 from the lower face portion 52 of the folder front 20. When the upper shield portion 22 is in its extended position, as illustrated in FIG. 11, the point of the barbed tongue 522 formed by the arrowhead shaped slit 523 points upwardly.

The second fastening element is formed by a linear, laterally extending slit 521 in the front lower face portion 52 of the front cover 20. The slit 521 is located below the laterally extending fold 220 the same distance that the shoulders 525 of the arrowhead shaped barbed tongue 522 are located above the laterally extending fold 220. The base of the arrowhead shaped tongue 522 defined by the shoulders 525 is slightly wider than the slit length of the slit 521. The barbed tongue 522 is thereby releasably engageable in the slit 521 when the upper shield portion 22 is folded downwardly into a face-to-face disposition against the upper region of the lower face portion 52. The tongue 522 may be squeezed laterally slightly so as to force the shoulders 525 toward each other slightly to allow the tongue 522 to enter the slit 521. The tongue 522 is resilient enough so that it can be bowed slightly upon insertion into the slit 521. The shoulders 525 of the tongue 522 extend outwardly a distance slightly greater than the length of the slit 521 so that once it is released, the tongue 522 will remain engaged in the slit 521, thereby holding at the upper shielding portion 22 against the lower face portion 52 of the front 20. The upper regions of the dividers 32 are then exposed to view and manual access until the tongue 522 is purposely removed from the slit 521.

It is to be understood that the location of the tongue 522 and slit 521 could be reversed. That is, the tongue 522 can be formed on the lower face portion 52, while the slit 521 can be defined in the upper shield portion 22.

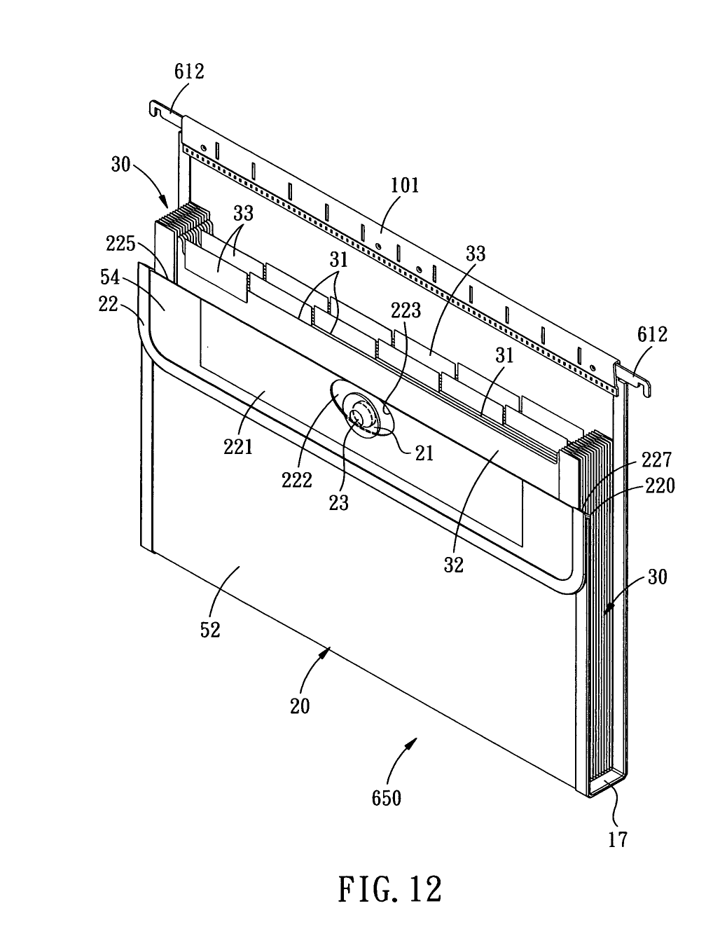

Other variations of the portable file folder of the invention differing in other respects from the portable file folder 50 are also possible. FIG. 12 illustrates a portable file folder 650 which is very similar to the portable file folder 50 in many respects. However, in the file folder 650 the top of the back cover 10 is provided with a pair of opposing, laterally outwardly projecting hooks 612. The hooks 612 allow the file folder 650 to be hung from its back 101 on a pair of support rails in a hanging file folder drawer or box.

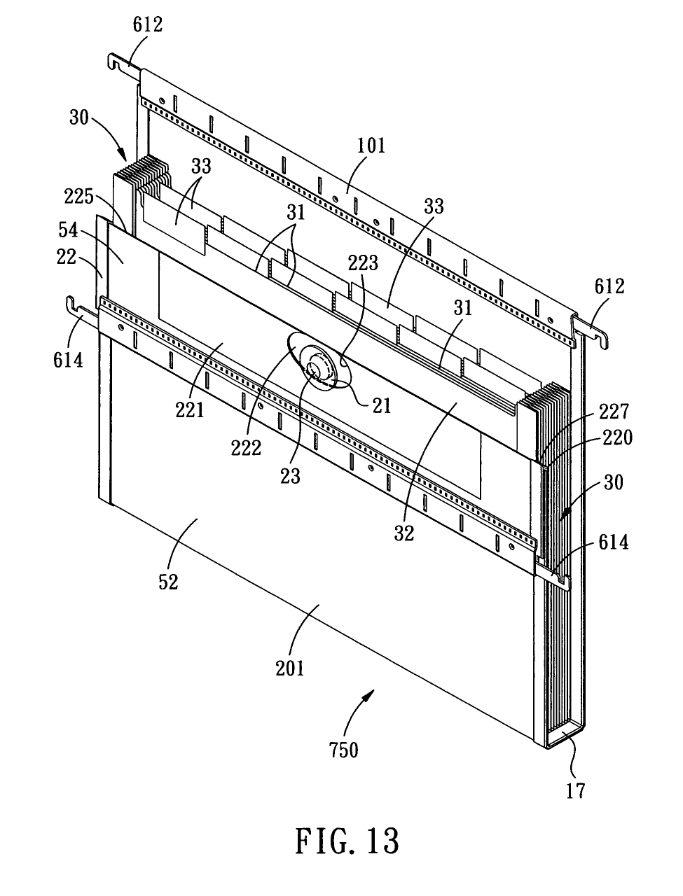

In the embodiment of the FIG. 13 the file folder 750 is further modified from the embodiment shown in FIG. 12 by additionally providing a pair of opposing, laterally outwardly projecting hooks 614 at the top of the upper shield portion 22 of the front 201. When the upper shield portion 22 is raised to its upwardly projecting, extended position, the file folder 750 is supported both front and back respectively by the hooks 614 and 612 on hanging support rails in an otherwise conventional hanging file folder drawer or box arrangement

Undoubtedly, numerous other variations and modifications of the invention will become readily apparent to those familiar with office supply products. Accordingly, the scope of the invention should not be construed as limited to this specific embodiments depicted and described, but rather is defined in the claims appended hereto.

I claim:

1. A file folder comprising: a back cover, a plurality of compartment dividers each having an upper edge and a lower edge located in front of said back cover and defining filing compartments, and a front cover located in front of said compartment dividers, wherein said front cover is formed with a lower face portion and an upper shield portion delineated from said lower face portion by a laterally extending fold that extends across the width of said front cover, and said upper shield portion is biased toward an extended disposition to project upwardly above said upper edges of said compartment dividers and further comprising a latch on said upper shield portion and a catch located on said lower face portion, and said catch is engageable with said latch when at least part of said shield portion is forced downwardly, bending in articulated fashion from said lower face portion, into a folded disposition facing said lower face portion.

2. A file folder according to claim 1 wherein said latch is comprised of at least one buttonhole opening formed in said upper shield portion and said catch is comprised of at least one button secured to said lower face portion, and said button is engageable in said buttonhole once said upper shield portion is in said folded disposition.

3. A file folder according to claim 2 further comprising an offset crease in said upper shield portion parallel to said laterally extending fold and passing through said buttonhole opening proximate said laterally extending fold to define an offset strip that aids in maintaining said button engaged in said buttonhole.

4. A file folder according to claim 3 further comprising an elastic band attached to said back cover and engageable with said button when said upper shield portion is in said extended disposition.

5. A file folder according to claim 1 wherein said catch and said latch are comprised of a pair of mating pads of hook and loop fastener material and one of said pads bears a multiplicity of minute hooks and the other of said pads bears a looped pile in which said hooks are releasably engageable.

6. A file folder according to claim 1 wherein said catch and said latch are comprised of a barbed tongue and a slot, and said barbed tongue is formed by an arrowhead shaped slit in one of said upper shield portion and said lower face portion and said slot is formed by a slit in the other of said upper shield portion and said lower face portion.

7. A file folder according to claim 1 wherein said catch and said latch are comprised of at least one snap fastener assembly that includes a socket and a stud that alternatively snaps into and free from said socket, and said socket and said stud are located on said front cover on opposite sides of said laterally extending fold.

8. A file folder according to claim 1 wherein said back cover has an upper end that includes a pair of opposing, laterally outwardly projecting hooks.

9. A file folder according to claim 8 wherein said upper shield portion has an upper end and also includes a pair of opposing, laterally outwardly projecting hooks to thereby provide hook supports both front and back.

10. A portable file folder comprising: a pocket in which a plurality of dividers are located, each divider having upper and lower extremities and said dividers delineate a plurality of compartments within said pocket, and said pocket has a back and a front, both of which are high enough to extend at least as high as said upper extremities of said dividers and said front includes a front upper portion and a front lower portion delineated from each other by a transverse fold extending across said front, whereby said front upper portion and said front lower portion lie on opposite sides of said transverse fold, and said front upper portion is biased to an extended position projecting upwardly from said front lower portion in front of said upper extremities of said dividers, and at least part of said front upper portion is foldable downwardly to bring said front upper portion to a collapsed position in which at least said part of said front upper portion is disposed against said front lower portion to expose said upper extremities of said dividers, and said front upper portion has a first fastening element and said front lower portion has a second fastening element that mates with said first fastening element and which engages said first fastening element when said front upper portion is in said collapsed position.

11. A portable file folder according to claim 10 wherein said first fastening element is comprised of a buttonhole opening defined in the structure of said front upper portion and said second fastening element is comprised of a button attached to said front lower portion and said button fits into said buttonhole opening when said front upper proportion is in said collapsed position.

12. A portable file folder according to claim 11 further comprising an elastic band secured to said back and which is stretchable over said plurality of dividers to engage said button when said front upper portion is in said extended position.

13. A portable file according to claim 11 further characterized in that said front upper portion is transversely delineated into an engagement flap and an intermediate offset strip by a transversely extending crease passing through said buttonhole opening so that said buttonhole opening is defined partially in said engagement flap and partially in said intermediate offset strip.

14. A portable file according to claim 10 wherein said back has a top from which a pair of file support engagement hooks extend laterally in opposite directions.

15. A portable file folder according to claim 14 wherein said front upper portion has a top with a pair of file support engagement hooks extending laterally in opposite directions therefrom.

16. A file folder having a back panel, a front panel and at least one divider disposed therebetween to delineate a plurality of compartments between said front and back panels, and said at least one divider has an upper region, and said front panel has a front lower portion and an upper shield portion delineated from said front lower portion by a transverse fold, and said upper shield portion is biased to project upwardly from said front lower portion in an extended condition in front of said upper region of said at least one divider, and said front panel is bendable to bring at least part of said upper shield portion into a folded condition facing said front lower portion, and said upper shield portion is provided with a first releasable fastening number and said front lower portion is provided with a second releasable fastening member engageable with said first releasable fastening member when said at least part of said shield portion is in said folded condition.

17. A file folder according to claim 16 wherein said first releasable fastening member is formed as a buttonhole opening defined in the structure of said front upper portion and said second releasable fastening member is formed as a button attached to said front lower portion and which fits into said buttonhole opening when said front upper proportion is in said folded condition.

18. A file folder according to claim 17 further comprising an elastic band secured to said back and which is stretchable over said at least one divider to engage said button when said front upper portion is in said extended condition.

19. A file folder according to claim 17 further characterized in that said front upper portion is transversely delineated into an engagement flap and an intermediate offset strip by a transversely extending crease passing through said buttonhole opening so that said buttonhole opening is defined partially in said engagement flap and partially in said intermediate offset strip.

20. A file folder according to claim 16 wherein said file folder is formed as an accordion file.
